(19) United States
(12) Patent Application Publication
(10) Pub. No.: US 2007/0262779 A1
(43) Pub. Date: Nov. 15, 2007

(54) Detection of unbalanced power feed conditions

(75) Inventor: Arthur F. Kirk, Naperville, IL (US)

Correspondence Address: Werner Ulrich, 434 Maple Street, Glen Ellyn, IL, 60137-3826, US

(73) Assignee: Lucent Technologies Inc.

(21) Appl. No.: 11/432,224

(22) Filed: May 11, 2006

(51) Int. Cl. G01N 27/02

(52) U.S. Cl. 324/439

(57) ABSTRACT

This invention relates to a method and apparatus for detecting and alarming unbalanced power feed conditions. A Hall effect device is clamped around a pair of power feed conductors. If the currents in the two power feeder conductors are unequal, i.e., unbalanced, this indicates a trouble condition and is alarmed. Advantageously, Hall effect devices are inexpensive and sensitive. Advantageously, this provides a continuous, inexpensive and sensitive arrangement for detecting unbalanced currents in a feeder pair during and after installation of a system.

### TECHNICAL FIELD

This invention relates to a method and apparatus for detecting and alarming unbalanced power feed conditions in both AC and DC power distribution applications.

### BACKGROUND OF THE INVENTION

A fault condition exists in a power distribution system when unequal currents appear in a pair of power feeder wires that supply power to a system or subsystem. For example, if a fault is present in a system or subsystem that causes part of the current to leak to earth ground, one of the two wires supplying power to the system will carry less current than the other since a part of the current that it would normally carry is being leaked to the earth ground. It has been recognized that the presence of unequal currents in power feeder wires is a cause of system inefficiencies, presents reliability issues, and a primary safety issue to the human interface. It is highly desirable to correct the fault condition as quickly as possible.

The present arrangements for detecting unequal current flow in a power feeder are not economical and not very sensitive. Typically, if a system is suspected of having unequal power feed currents in the two directions, a clamp-on current meter may be placed successively on the two power feeder wires and if the readings are different this is an indication of an unbalanced power feed current. Monitoring the current in the two directions individually on a steady basis can also provide the information necessary to determine that the currents are unbalanced. Ground Fault Interruption Circuitry (GFCI) may also be employed but these devices remove power when a fault condition is detected.

A problem of the prior art therefore is that there is no quick, economical, and sensitive arrangement for detecting unbalanced currents in a pair of power feeders during installation or while the circuit is operating.

### SUMMARY OF THE INVENTION

The above problem is overcome and an advance is made over the teachings of the prior art in accordance with this invention wherein a clamp-on device is installed around a power feeder pair normally carrying equal and opposite currents. The clamp-on device contains a Hall effect device. When the probe is clamped around two conductors with different polarities, the resulting reading will be the difference between the two currents. If the currents are the same, the reading will be zero. When a reading other than zero is obtained, the reading is proportional to the amount of leakage current that is occurring. The reading is then converted into an alarm signal for providing alarm information with respect to the pair of power feeder wires being monitored. Advantageously, this arrangement provides a continuous, inexpensive, and sensitive method and apparatus for detecting unbalanced currents in a feeder pair during and after installation of the system.

In accordance with one aspect of Applicant's invention, monitoring devices may be installed on various feeders of a system. Each monitoring device can be connected to send an alarm signal to a centralized alarm control system wherein an alarm controller controls audible alarms and/or visual alarms for use by the craft attending a system. Advantageously, this arrangement allows the craft to rapidly identify, locate, and isolate the faulty area.

Hall effect devices can be used for both AC and DC applications. They can be programmed for sensitivity ranging from milliamps to several hundred amperes. The Hall effect devices are commonly available and inexpensive.

### BRIEF DESCRIPTION OF THE DRAWINGS

FIG. 1 illustrates the basic principle of the operation of Applicant's invention;

FIG. 2 illustrates how a Hall effect device is attached to power feeders;

FIG. 3 illustrates the normal operation of a Hall effect detector and alarm;

FIG. 4 illustrates the operation of the Hall effect detector when leakage current to earth ground occurs; and

FIG. 5 illustrates an alarm control arrangement.

### DETAILED DESCRIPTION

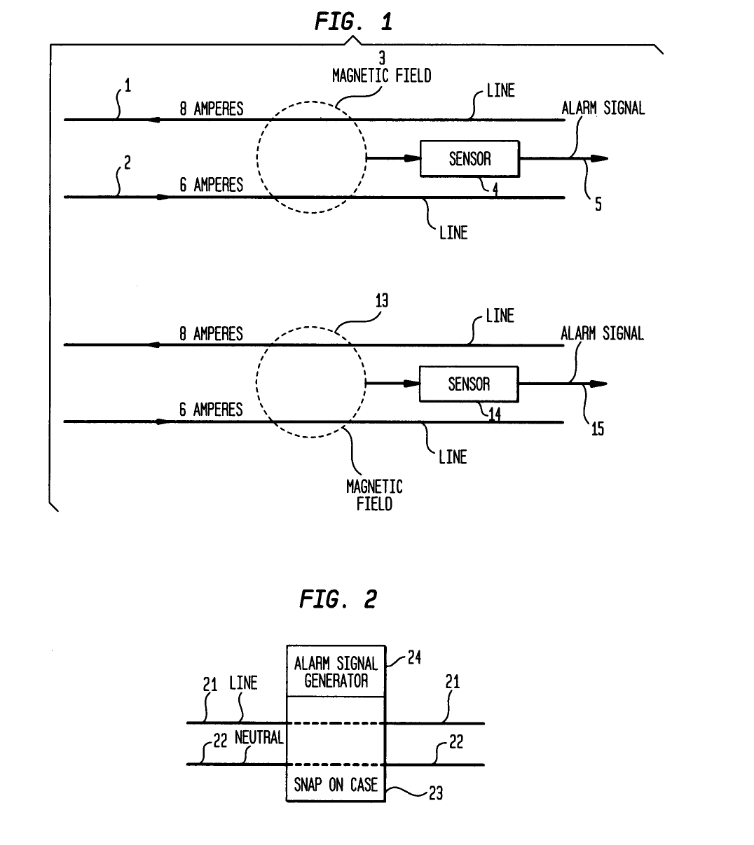

FIG. 1 illustrates the principle of operation of Applicant's invention. Wires 1 and 2 each carry identical currents, in this case eight amperes, in opposite directions. A Hall effect device with sensor 4 is clamped around the two wires and detects the net magnetic field generated by the two wires. Wire 2 carries less current than wire 1 and so there is a net magnetic field 3 in the Hall effect device surrounding the wires. This turns on sensor 4 of the Hall effect device which sends an alarm signal 5 to an alarm unit.

In contrast, wires 11 and 12 carry equal and opposite electric currents so that the net magnetic field 13 surrounding these two wires is zero. Consequently, sensor 14 detects no net magnetic field and does not send an alarm signal 15 to the associated alarm unit.

FIG. 2 shows the apparatus arrangement wherein two lines, line 21 and neutral 22, both go through a snap on case 23 which contains the Hall effect device. An alarm unit signal generator 24, which can either be a part of the snap on case or a separate unit driven by the Hall effect output of the Hall effect device in snap on case 23, drives an alarm system.

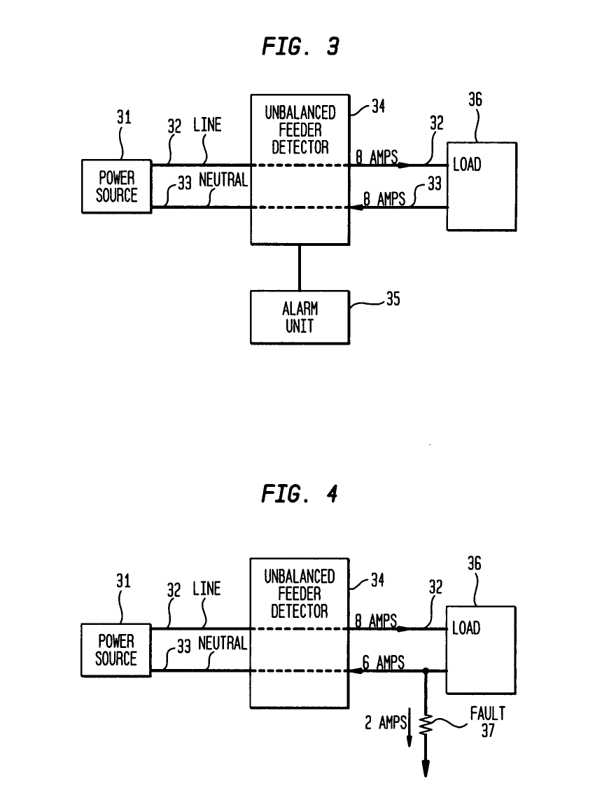

FIG. 3 shows the normal operation of the system wherein the power source 31 sends power over line 32 and receives an equal (eight amperes) and opposite return over neutral wire 33. The unbalanced feeder detector 34 generates no signal to the alarm unit 35 when the two currents which feed load 36 are balanced.

FIG. 4 illustrates the operation of Applicant's invention. Under a fault condition, the power unit sends out eight amperes over line 32 but receives back only six amperes over neutral return 33. A fault 37 is diverting two amperes to ground. Under these circumstances, the unbalanced feeder current detector 34 generates an alarm signal when these currents are unequal and transmits that alarm signal to alarm unit 35.

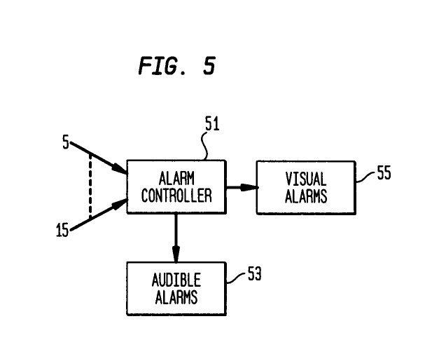

FIG. 5 illustrates alarm controller 51 which receives signals such as signal 5, . . . , 15 from a plurality of units and generates audible alarms 53 and/or visual alarms 55 of the current state of the power feed systems being monitored.

The above description is of one preferred embodiment of Applicant's invention. Other embodiments will be apparent to those of ordinary skill in the art. The invention is limited only by the attached claims.

I claim:

1. A method of detecting unbalanced currents in power feeder conductors comprising the steps of:
clamping a Hall effect device around a pair of balanced feeder conductors;
connecting an output of said Hall effect device to an alarm controller.

2. The method of claim 1 wherein a plurality of Hall effect devices, each for monitoring a different pair of balanced feeder conductors, are connected to a common alarm controller.

3. The method of claim 2 wherein said common alarm controller comprises a controller system for controlling an audible or visual alarm signal.

4. The method of claim 1 wherein said power feeder conductors provide power to a telecommunications system.

5. The method of claim 1 wherein said power feeder conductors carry direct current.

6. The method of claim 1 wherein said power feeder conductors carry alternating current.

7. Apparatus for detecting unbalanced currents in power feeder conductors comprising:
a Hall effect device clamped around a pair of balanced feeder conductors; and
an output of said Hall effect device connected to an alarm controller.

8. The apparatus of claim 7 further comprising:
a plurality of Hall effect devices, each for monitoring a different pair of balanced feeder conductors, and each connected to a common alarm controller.

9. The apparatus of claim 8 wherein said common alarm controller comprises a controller system for controlling an audible or visual alarm signal.

10. The apparatus of claim 7 wherein said power feeder conductors provide power to a telecommunications system.

11. The apparatus of claim 7 wherein said power feeder conductors carry direct current.

12. The apparatus of claim 7 wherein said power feeder conductors carry alternating current.
